(19) United States
(12) Patent Application Publication
(10) Pub. No.: US 2010/0202143 A1
(43) Pub. Date: Aug. 12, 2010

(54) Illumination Device and Actively Illuminated Article

(76) Inventors: Michael Ruehlemann, Korschenbroick (DE); Dorothee B. Loosen, Moenchengladbach (DE)

Correspondence Address: 3M INNOVATIVE PROPERTIES COMPANY, PO BOX 33427, ST. PAUL, MN, 55133-3427, US

(21) Appl. No.: 12/677,562

(22) PCT Filed: Sep. 3, 2008
(86) PCT No.: PCT/US2008/075075

§ 371 Date: Mar. 11, 2010

(30) Foreign Application Priority Data
Sep. 18, 2007 (EP) 07116685.4

(51) Int. Cl. F21S 4/00; F21V 7/00; F21V 9/16

(52) U.S. Cl. 362/249.01; 362/307; 362/260

(57) ABSTRACT

The present invention relates to an illumination device (20) comprising a light source (4). and at least one light transmissive film (2) arranged above said light source (4) so that at least part of the light emerging from the light source (4) is transmitted through said film (2), wherein said film (2) has a first major surface facing the light source (4) and a second major surface arranged opposite to said first surface, said light-transmissive film (2) being diffusive for transmitted light incident from the light source (4) on the first major surface and retroreflective for light incident on said second major surface.

### FIELD OF THE INVENTION

The present invention relates to an illumination device comprising a light source and a light-transmissive film arranged above said light source. The light-transmissive film is selected so that the illumination device exhibits, if required, a more uniform luminance distribution in comparison to the luminance distribution of the light source without such light-transmissive film. The present invention furthermore relates to an actively illuminated article comprising a substrate and the illumination device of the present invention. The present invention furthermore refers to textile articles comprising an illumination device according to the present invention and a textile substrate.

### BACKGROUND OF THE INVENTION

Light sources having a non-uniform distribution of the luminance along at least one arbitrarily selected linear direction on the light source have been suggested for use in actively illuminated textile articles.

WO 2004/100,111 discloses a flexible textile display comprising a material support of woven threads including electrically conducting threads, discrete electroluminescent sources soldered to the conducting threads and control and supply means for the energy supply of the electroluminescent sources, whereby the conducting threads are addressable in an individually selectable manner.

WO 2006/129,246 discloses a light-source comprising one or more discrete lighting units such as, for example, one or more light emitting diodes (LEDs). The light source furthermore includes a diffusing element being arranged to receive and diffuse light emitted by the lighting units whereby such diffusing element comprises at least one layer of non-woven fabrics with the density of the diffusing element being lower at a first side of the diffusing element facing a lighting unit compared to the density at a second side of the diffusing element opposite to said lighting unit. The light-source may comprise at least two lighting units whereby the diffusing element diffuses light emitted by two adjacent lighting units to produce a substantially continuous light display on a face of the diffusing element opposite to said lighting units. WO '246 discloses the use of the light source for light emitting textile applications.

While it is often desirable to apply illumination devices to textiles such as garments, accessories like bags, back-packs, emblems and logos or security markings and emblems on trucks, bicycles or the like, it is often furthermore required from a security standpoint to also provide retro-reflective properties to such articles. The illumination devices known so far do not provide retro-reflective properties so that one or more retro-reflective element has to be applied in addition to an illumination device.

The diffusing elements known in the state of the art do furthermore not always provide a sufficiently uniform and/or aesthetically pleasing distribution of light from a light source having a non-uniform luminance distribution.

It is an object of the present invention to provide illumination devices which are an alternative to illumination devices available in the prior art and/or do not exhibit the shortcomings of the prior art devices or exhibit them to a lesser degree only, respectively. It is another object of the present invention to provide illumination devices having a more uniform luminance distribution in comparison to the luminance distribution of the light source comprised in such luminance device, and additionally retro-reflective properties. It is another object of the present invention to provide actively illuminated articles such as actively illuminated textile articles comprising such illumination devices. Other objects of the present invention will became apparent from the following description of the invention.

### SHORT DESCRIPTION OF THE INVENTION

The present invention relates to an illumination device comprising a light source and at least one light-transmissive film arranged above said light source so that at least part of the light emerging from the light source is transmitted through said film, wherein said film has a first major surface facing the light source and a second major surface arranged opposite to said first surface, said light-transmissive film being diffusive for transmitted light incident from the light source on the first major surface and retroreflective for light incident on said second major surface. The illumination device of the invention preferably comprises a light source exhibiting a non-uniform distribution of luminance in an arbitrarily selected direction on the light source.

The present invention furthermore refers to an actively illuminated article comprising a substrate having an exposed major surface and an illumination device according to the invention which is attached to an exposed major surface of the article or arranged subjacent to it.

### SHORT DESCRIPTION OF THE FIGURES

FIG. 1a is a schematic cross-sectional view of a first embodiment of an illumination device of the present invention. FIG. 1b is another schematic cross-sectional view showing a detail of the illumination device of FIG. 1a.

FIG. 2 is a schematic cross-sectional view showing a detail of another embodiment of an illumination device of the present invention.

FIG. 3a is a schematic cross-sectional view of another embodiment of an illumination device of the present invention comprising a rod-shaped light guide member having a circular cross-section.

FIG. 3b is another schematic cross-sectional view showing a detail of the illumination device of FIG. 3a.

FIG. 3c is a schematic top view of the illumination device of FIG. 3a. FIG. 3d is a schematic cross-sectional view of another embodiment of an illumination device of the present invention, comprising a rod-shaped light guide member having a rectangular cross section.

FIG. 4a is a photograph showing a colour-coded image of the illumination device disclosed in Example 1.

FIG. 4b is a plot showing the luminance distribution along the central longitudinal axis on the illumination device disclosed in Example 1.

FIG. 5a is a photograph showing a colour-coded image of the illumination device disclosed in Comparative Example 1.

FIG. 5b is a plot showing the luminance distribution along the central longitudinal axis on the illumination device disclosed in Comparative Example 1.

### DETAILED DESCRIPTION OF THE INVENTION

The light source used in the illumination device of the present invention preferably has a non-uniform distribution of the luminance at least along one arbitrarily selected linear direction on the light source. The luminance distribution measured along such direction by using the method specified in the test section below, preferably exhibits at least two peaks or areas with a higher level of luminance as compared to the level of luminance in the area between such peaks. The peak areas with a higher level of luminance preferably are at least 0.1 mm and more preferably at least 0.5 mm wide. The areas with a lower level of luminance which separate the peak luminance areas from each other preferably are at least 0.1 mm and more preferably at least 0.2 mm wide. The ratio of the average luminance in the peak areas over the average luminance in the areas with a lower level of luminance preferably is at least 1.1, more preferably at least 1.2 and especially preferably at least 1.25. The ratio of the contrast C of the highest value of the luminance over the lowest value of the luminance (as defined in the test method section below) preferably is at least 1.25 and more preferably is at least 1.3. The variance of the luminance of the illumination device or the light source alone, respectively, along an arbitrarily direction on the light source is described in the test method section below by the root mean square value RMS. The ratio of the RMS value for the light source alone (without a light-transmissive film) over the RMS value of the illumination device preferably is between 2 and 40 and more preferably between 3 and 40.

The light source suitable for use in the illumination device of the present invention may comprise two or more discrete lighting units (i.e. light emitting units or members) which are arranged in a distance from each other. The lighting units may each exhibit an essentially uniform luminance or they may each exhibit an inhomogeneous distribution of the luminance.

Suitable discrete lighting units useful in the present invention include, for example, light emitting diodes (LEDs), discrete electroluminescent light sources, or conventional lighting units like neon tubes or light bulbs that are equipped, for example, with a mask of opaque material providing a discrete pattern to the emitted light. LEDs are preferred because they typically have a high luminous efficacy in combination with a low power consumption. LEDs are typically operated with a power consumption of 30-60 mW but there are also LEDs such as the so-called Lumi-LEDs introduced by Philips at the end of the 90ies which can be operated at distinctly higher powers. LEDs which are useful in the present invention comprise LEDs which are capable of emitting light in the spectral range from IR to UV and, in particular, in the visible spectral range from about 350 to about 700 nm. Suitable LEDs comprise, for example, organic and/or polymer based LEDs such as OLEDs, inorganic LEDs such as UV/blue and white LEDs, and laser diodes.

The two or more discrete lighting units are arranged in a distance from each other. Preferably, adjacent lighting units are arranged in a distance of at least 0.5 mm, more preferably of at least 1 mm and particularly preferably of at least 1.2 mm from each other.

The two or more discrete lighting units can be arranged in a regular pattern so that the light source can display, for example, a message, logo or emblem. In other applications, such as interior illumination applications, a random distribution of the two or more lighting units may be preferred. The two or more discrete lighting units are preferably individually addressable. If desirable, the illumination device may furthermore comprise a communication device adapted to receive data and an interface means adapted to address the discrete lighting units and control their light emission. The communication means may include, for example, a mobile phone or an Internet connection interface.

The light source suitable for use in the illumination device of the present invention may furthermore comprise one or more light guide members each having at least two discrete light extraction elements (also termed as elements coupling out light) that are spaced from each other. The light guide member is capable of piping light allowed to impinge on one or both ends of the light guide member towards the respective other end. The light guide member is preferably rod-shaped and exhibits, for example, an essentially circular, rectangular or elliptical cross-section so that the light impinging on one or both ends is guided in the longitudinal direction to the other end. The light guide member furthermore preferably exhibits a relatively low height or thickness, i.e. is essentially flat. The light guide member has along its longitudinal extension at least two light extraction elements which are preferably provided by reflecting surfaces extending into said light guide member. The two or more reflecting surfaces are arranged in a distance from each other along the longitudinal extension of the light guide member such that a portion of light propagating along the light guide member and impinging on such surfaces will be reflected by total internal reflection at said surfaces and pass out of the light guide member through a side wall thereof. The reflecting surfaces are of optical quality such that only a portion of the light incident upon them is diffusively scattered. The reflecting surfaces are preferably substantially planar and may be formed, for example, by the walls of two or more notches which are arranged along the longitudinal extension of the light guide member. The reflective surfaces are preferably regularly or irregularly spaced at least 50 μm.

The light guide member may comprise any suitable light transmissive material including both inorganic glass and polymeric resins. Polymeric resins are preferred because they can be molded into any desired shape and are usually flexible. Notches may also be more easily applied to plastic materials. The polymeric resins used preferably have a refractive index of from 1.4 to 1.7 as measured with visible light at room temperature. Especially preferred materials are thermosetting polyurethane resins which provide high optical clarity and aging resistance.

The rod-shaped light guide member may have any useful cross-sectional shape including essentially circular, rectangular or elliptical cross-sections. Light guide members having an essentially circular cross-section typically have diameters of between 5 μm and 15 mm. Light guide members having an essentially rectangular cross section typically have a cross-sectional thickness of between 5 μm and 20 mm and a cross-sectional width of between 5 μm and 500 mm. The length of the rod-shaped light guide member may vary—depending on the application—between a few mm and up to 100 m, for example. For actively illuminated textile articles the cross-sectional extension of a rod-shaped light guide member may be between 1 mm and 50 mm, it preferably is between 1 and 20 mm and more preferably between 2 and 15 mm, and the longitudinal extension typically is between 1 cm and 5 m and more preferably between 5 cm and 2 m. For actively illuminated textile articles the cross-sectional width of an essentially flat light guide members may be between 2 mm and 500 mm, preferably between 5 and 50 mm and more preferably between 10 and 15 mm. The cross-sectional height or thickness of the essentially flat light guide member may be between 0.5 mm and 20 mm, preferably between 1 mm and 10 mm and more preferably between 1 mm and 5 mm. The longitudinal extension of an essentially flat light guide member typically is between 1 cm and 5 m and more preferably between 5 cm and 2 m.

The light source comprising one or more light guide members furthermore comprises one or more lighting units generally positioned at one or both ends of the light guide member so as to transmit light into such light guide member. The light source may comprise any suitable lighting unit including both continuous and pulsed lighting units such as LEDs, lamp bulbs or lasers emitting in a spectral range from IR to UV and more preferably in the visible spectral range. The angular distribution of the light emitted from the reflective surfaces of the illuminated light guide member can be controlled, for example, for a given cross-section of the light guide member by the angle of such reflective surfaces and the extension and/or the number of the reflective surfaces around the cross-sectional circumference. The luminance distribution of the light guide member along its longitudinal extension is characterized by a sequence of at least two peaks or areas with a higher level of luminance as compared to the level of luminance in the area between such peaks. The variation of the luminance along the longitudinal extension is controlled, for example, by the type of the extraction element, the number and pattern of the extraction elements and the distance between adjacent extraction elements. It is disclosed, for example, in EP 0,594,089 that the luminance in the peak areas along the longitudinal extension of the light guide member can be made more homogenous by decreasing the distance between adjacent reflective surfaces along such longitudinal extension whereby at least one reflecting surface has a cross-sectional area less than that of the light guide member.

Rod-shaped light guide members which comprise optical surfaces such as notches that project into the light guide member to extract light along the longitudinal extension of the rod in a pattern determined by the geometry and the number of such notches, are commercially available from 3M Co., St. Paul, Minn., U.S.A. under the designation Precision Lighting Elements. Rod-shaped light guide members and their method of making are disclosed, for example, in EP 0,594,089 and, in particular, in sections [0017]-[0084] on pp. 3-12 of the B1 publication which are incorporated herein by reference.

The specific light sources described above are given by way of example but do not limit the scope of the present invention in any way.

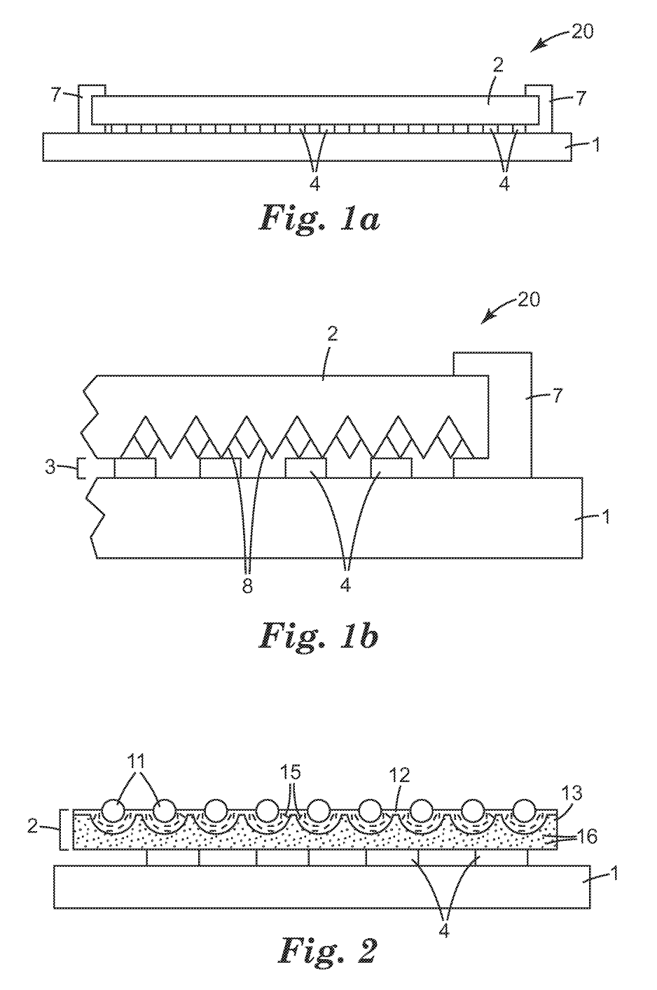

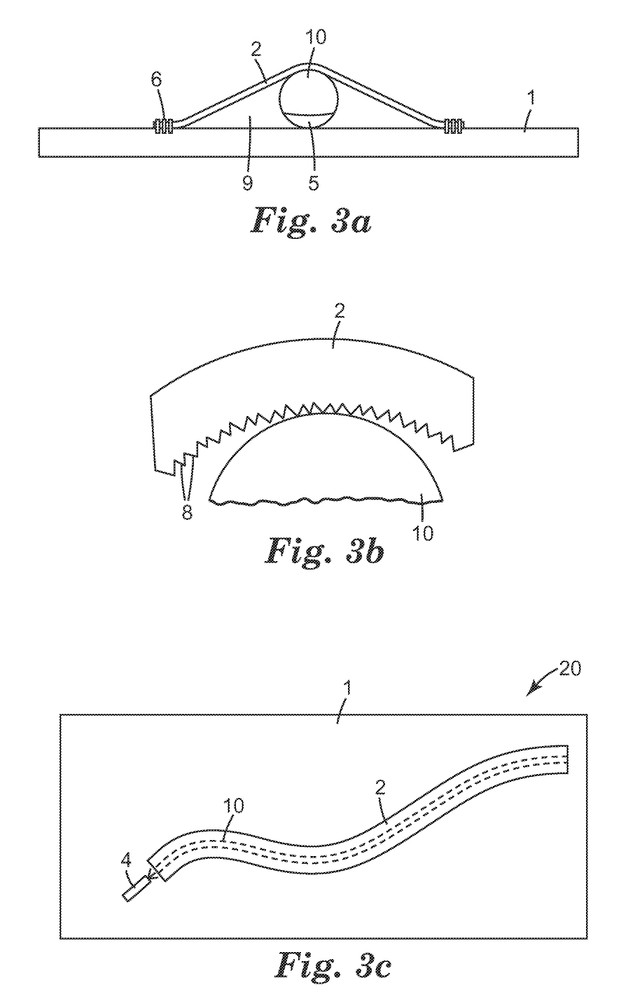

The illumination device of the present invention furthermore comprises at least one light-transmissive film arranged above the light source so that at least part of the light emerging from the light source is transmitted through said film. The extension of the light-transmissive film is preferably selected in view of the specific application so that the light emitted from said light source in the applicable viewing angle is essentially transmitted through said light-transmissive film. FIG. 1 schematically shows an arrangement where the light-transmissive film is arranged in parallel to the substrate bearing the light source comprising an array of diodes; the light emitted sideward from the light source is not transmitted through the light-transmissive film. FIG. 3a schematically shows another arrangement where the light-source which comprises a rod-shaped light guide member, is embraced by the light-transmissive film and the substrate which bears the rod-shaped light guide member. These geometries are given by way of example and do not limit the invention in any way.

It is required that the film is light-transmissive. This means that the ratio of the intensity I of visible light passing through such film over the intensity I₀ of the light before it passes through such film is larger than 0, preferably at least 0.3, more preferably at least 0.5 and especially preferably at least 0.65. The ratio I/I₀ is called transmittance and can be measured by using a photometer following the procedure described in the German Standards Document DIN 5036 part 3, dated 1979.

The light-transmissive film useful in the present invention has an extension in two directions (usually referred to as length and width of the film) which usually are distinctively larger than the extension in a third direction (usefully referred to as the thickness of the film) which is normal to said two directions. The light-transmissive film preferably has a thickness of between 1 μm and 10 mm and more preferably between 10 μm and 2 mm. The width and the length of the light-transmissive film preferably are each at least as great as the extension of the light source in these directions, respectively. The exposed surfaces of the light-transmissive film defined in each case by the width and the length of the light-transmissive film are referred to above and below as first and second major surfaces, respectively, of the light transmissive-film.

The light-transmissive film is arranged over the light source so that at least part of the light emitted by the light source is transmitted through said light-transmissive film. The light-transmissive film may be arranged in a distance of, for example, 10 μm to a few mm above the upper surface of the light source but it is usually preferred that the light-transmissive film is in contact with the upper surface of the light source. In the present invention the light-transmissive film is selected so that it meets the following requirements:
(i) The light-transmissive film is diffusive for light incident from the light source on its first major surface facing the light source.
(ii) The light-transmissive film is furthermore retro-reflective for light first incident, in the direction of the light source, on its second major surface opposite to said first major surface.

A light-transmissive film is qualitatively characterized as diffusive if the film allows light to pass through it but if a view through the film from a distance of about 1 m with the unaided eye is blurry, hazy or distorted. In other words, if an object is viewed through a light-transmissive diffusive film the image of the object appears blurry, hazy or distorted. Light-transmissive diffusive films are frequently also termed as translucent.

A quantitative assessment of the property of light diffusion is described in the test method section below.

The surface of a light-transmissive film is termed as retro-reflective if the structure of the surface is such that at least part of the light incident on the surface is essentially returned in the direction from which it came. An easy qualitative determination of whether a surface is retroreflective can be made using a hand-held device distributed and sold by 3M Co., St. Paul, Minn., U.S.A. under the trade designation “3M Confirm™ Handheld Verifiers”. This method is described in the test section below. The retro-reflection of the second major surface of the light-transmissive film is quantitatively characterized by the coefficient of retroreflection (in cd lx⁻¹ m⁻²) as is described in the test method section below. If that coefficient is larger than preferably 5 cd lx⁻¹ m⁻², more preferably larger than 10 cd lx⁻¹ m⁻² and, particularly, larger than 15 cd lx⁻¹ m⁻² retroreflection is present on the second surface of the light-transmissive film. If that coefficient is smaller than 1 cd lx⁻¹ m⁻², the second surface of the light-transmissive film can not be considered retro-reflective in the scope of this invention.

Light-transmissive films suitable for use in the present invention are preferably selected so that they exhibit
(i) a high transmittance along their surface normal for visible light of at least 0.3 and more preferably of at least 0.5;
(ii) a sufficient diffusion property so that the contrast C (defined in the test methods section below) as measured for an illumination device comprising the non-uniform light source used in Example 1 and such light-transmissive film is, relative to the light source alone without the light-transmissive film, at least 1.3;
(iii) a sufficient retroreflection as determined by the qualitative test method described in the test method section below and/or by a coefficient of retroreflection for light which is incident on the second major surface of the light-transmissive film, of at least 5 cd lx⁻¹ m² and more preferably of at least 10 cd lx⁻¹ m²

A preferred class of light-transmissive films useful in the present invention is based on retro-reflective sheetings using an array of cube-corner elements to retro-reflect light whereby such sheetings or the construction of such sheetings, respectively, have been modified to provide films having both light diffusion and retro-reflection properties.

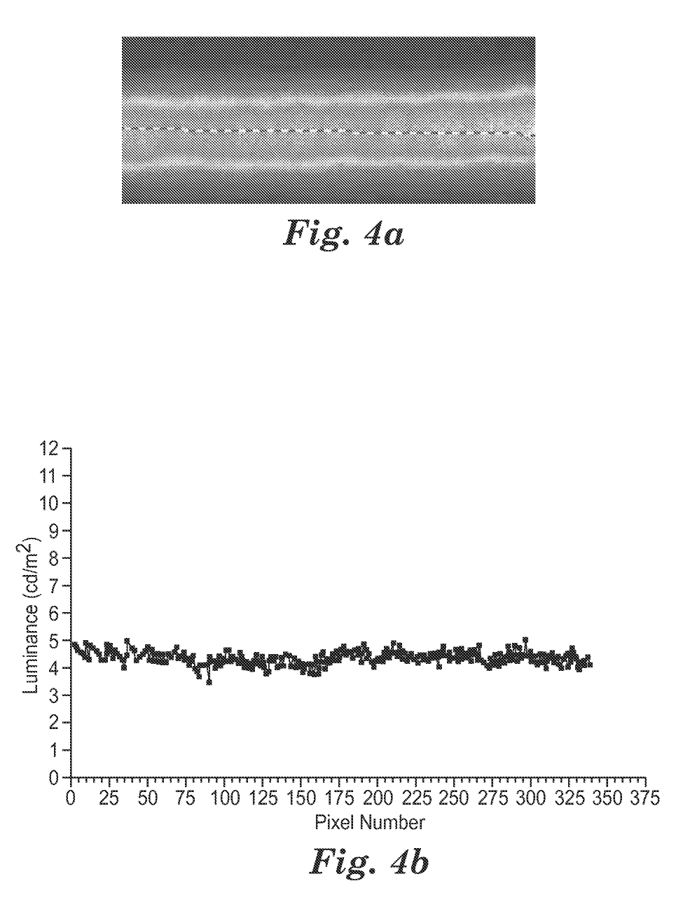

EP 0,896,683 discloses a method of making a glittering cube-corner retro-reflective light-transmissive film comprising the steps of (a) providing a retro-reflective sheeting that includes an array of cube-corner elements arranged in a repeating pattern; and (b) exposing the retro-reflective sheeting to heat, pressure or a combination thereof to produce a second glittering retro-reflective and diffusive light-transmissive film useful in the present invention. In a preferred embodiment disclosed in sections [0031]-[0038] and [0065] and in FIGS. 4-6 and 12 of EP '683 (which are hereby incorporated by reference) a retro-reflective sheeting comprising cube-corner elements in a non-random, ordered configuration is exposed to sufficient heat and/or pressure by passing the retro-reflective sheeting through heated nip rolls so that the resulting light-transmissive film exhibits cube-corner elements that are randomly tilted. Also, the dihedral angles formed between adjacent cube-corner elements may vary along each groove in the array. When arranging the resulting light-transmissive sheeting above a light-source so that the side comprising the tilted cube-corner elements is oriented towards the light source, a sparkling image of the light source is viewed through the light-transmissive film. The heat and/or pressure treatment of the precursor retroreflective sheeting has introduced the sparkling effect into the light-transmissive film which represents its diffusive properties while maintaining the retro-reflective properties at a somewhat decreased level.

In order to maintain a sufficient level of retroreflectivity, it is preferred to arrange the light-transmissive film over the light source in a manner so that preserves an air interface is present between the cube-corner element surface of the light-transmissive film and the surface of the light source that are oriented towards the light source. The use of adhesive, liquid, or any other material having a refractive index distinctly different from that of air, on the surfaces of the cube-corner elements will distinctly decrease the retro-reflective properties of the light-transmissive film. Retroreflection is, however, not or only marginally reduced if the vertices of the cube-corner elements touch the surface of the light source, as is depicted, for example, in FIG. 3b below. This arrangement is therefore preferred.

Light-transmissive films which are both retro-reflective and sparkling, i.e. diffusive, are available from 3M Co., St. Paul, Minn., U.S.A. under the trade designation Scotchlite™ Reflective Material—Series 6500 including the 6560 White High Gloss Sparkle Film. These films are especially preferred for use in the illumination devices of the present invention.

U.S. Pat. No. 5,272,562 discloses light-transmissive, retro-reflective diffusive materials obtained from a retro-reflective cube-corner sheeting by dispersing white opaque pigment particles in front of the cube-corner elements.

Another preferred class of light-transmissive films useful in the present invention is obtained by introducing diffusive properties into retro-reflective sheetings comprising a monolayer of transparent beads partly embedded in a light transmissive binder layer whereby a reflective material is arranged behind the beads so that the focal surface of the transparent beads partly coincides with the surface of the reflective material. The reflective material layer is preferably curved and particularly essentially spherical. A light-transmissive film comprising both diffusive and retro-reflective properties can be obtained when the reflective material layer comprises reflective pigments such as, for example, pearlescent pigments or metal flakes which are arranged, preferably in a cup-like fashion, behind the partially embedded glass beads (see, e.g., U.S. Pat. No. 3,758,192). The degree of retro-reflectivity can be varied, for example, by varying the concentration of the pearlescent pigments or metal flakes and the diffusive properties can be further enhanced by including pigments such as, for example, TiO₂. Reference is made, in particular, to the passage in col. 4, ln. 6 to col. 7, ln. 14 of U.S. Pat. No. 3,758,192 which passage is herewith incorporated by reference.

Light-transmissive, diffusive and retro-reflective films which comprise exposed glass beads partially embedded in a binder comprising pearlescent pigments and TiO₂ pigments glass are commercially available from 3M Co., St. Paul, Minn., U.S.A. under the trade designation Scotchlite™ Reflective Material—8965 White Fabric. These materials are additionally characterized by a good washing and cleaning durability and by a good abrasion and chemical resistance and are therefore particularly useful in actively illuminated articles of the present invention.

The specific light-transmissive films described above are given by way of example only and do not limit the scope of the present invention in any way.

The illumination device of the present invention exhibits both diffusive and retro-reflective properties. Because of its diffusive properties the illumination device of the present invention is able to at least partly even out the non-uniform character of the light emitted from its light-source which is the more advantageous the more non-uniform the luminance distribution of a particular light source is. As a result of its retro-reflective properties the illumination device of the present invention exhibits when passively illuminated, an increased brightness when viewed in the direction of the passive illumination (i.e. in a non-specularly reflective direction).

The illumination device of the present invention thus offers a unique combination of an at least partly evened out active light-emission with a retro-reflective passive brightness which can be observed from the direction from which the illumination device is passively illuminated. This combination is advantageous because the diffusive properties while providing a more uniform luminance distribution of the illumination device, also tend to reduce its absolute luminance level which can be observed in a given direction. This is countervailed by the retro-reflective properties of the illumination device which provide an increased brightness in the direction of incidence of the passive light.

This combination makes the illumination device of the present invention particularly suitable for applications requiring an aesthetically pleasing illumination under daylight conditions and an enhanced visibility during darkness and low light conditions.

The present invention furthermore relates to actively illuminated articles comprising a substrate having an exposed major surface and an illumination device according to the present invention which is attached on or subjacent to said exposed major surface. The illumination device of the present invention can be attached to various substrates including flexible or non-flexible substrates comprising surfaces such as textile surfaces including woven and non-woven surfaces, metal surfaces, polymeric surfaces, wooden surfaces, painted or coated surfaces and the like. Preferred textile substrates are selected from the group comprising pillows, furnishing fabric, garments, gloves, banners, flags, carpets, curtains, vehicle ceilings, bed textiles, toys, handbags, hats and backpacks.

Suitable substrates preferably comprise at least one polymeric material which is preferably selected from a group of materials comprising optionally substituted vinyl, polyurethane, polyester, polypropylene, polycarbonate, poly methyl methacrylate, and polyethylene polymers or copolymers, respectively, or any blend thereof. Substrates may have a thickness of 1 micron to 5 centimeters. Preferably, substrates have a thickness of between 10 microns and 2 millimeters, and more preferably a thickness of between 100 microns and 1 millimeter.

Suitable substrates include those substrates that have two or more layers of said textile substrates or said polymeric substrates or both, attached to each other. In a preferred embodiment, those layers are cold or hot laminated to each other or adhesively attached to each other. Those layers may also be attached to each other by other methods, for example by welding, sewing, stitching or by a combination of any of the methods described herein.

Substrates may be essentially flat and have two major surfaces. A substrate may have a surface structure on one or on both of its major surfaces. The surface structure may comprise a plurality of protruding or embossed elements. The surface structure may comprise a regular or irregular pattern of elements. The surface structure may comprise elements that have essentially the same shape, or it may comprise elements that have different shapes. The surface structure may comprise elements that have essentially the same size or it may comprise elements that have different sizes. Embossed surface structures are preferred because they are aesthetically more pleasing.

Substrates may be coloured on one side or they may be coloured on both sides. The colour on one side can be different from the colour on the other side. The colour on the major surface of the substrate facing the illumination device may be chosen such as to provide a colour effect in combination with the colour of the light emitted by the illumination device.

The major surface of the substrate facing the illumination device may have a plurality of coloured areas, wherein these coloured areas may have essentially the same colour, or may have different colours. Said coloured areas may have geometric shapes like circles, rectangles, ovals, ellipses, or they may have the shape of characters of a writing system, or they may have the shape of logos, trademark signs or brand identifiers, or they may have an irregular or random shape, or any combination of such shapes. Any number of said coloured areas may have the same geometric shape or they may have different shapes. Any number of coloured areas may be arranged to form, when viewed from a certain distance, geometric shapes like circles, rectangles, ovals, ellipses, or they may be arranged to form characters of a writing system, or they may be arranged to form logos, trademark signs or brand identifiers, or they may be arranged to form essentially an irregular or random shape, or any combination of such shapes. Any number of coloured areas may be arranged to form, when viewed from a certain distance, a homogenous colour or a colour gradient.

The major surface of the substrate facing the illumination device may be diffusely reflecting or specularly reflecting or retro-reflecting or absorbing for light of different wavelength regimes. The major surface of the substrate facing the illumination device may be highly reflective in certain areas, or it may be retro-reflective in certain areas. The major surface of the substrate facing the illumination device may be highly absorbing in certain areas. The major surface of the substrate facing the illumination device may have any combination of diffusely reflecting or specularly reflecting or retro-reflecting or absorbing areas, respectively.

Areas of the major surface of the substrate facing the illumination device being diffusely reflective, specularly reflective, retroreflective, or absorbing, may have geometric shapes like circles, rectangles, ovals, ellipses, or they may have the shape of characters of a writing system, or they may have the shape of logos, trademark signs or brand identifiers, or they may have an irregular or random shape, or any combination of such shapes. Any number of said areas may have the same geometric shape or they may have different shapes. A plurality of areas being diffusely reflective, specularly reflective, retroreflective, or absorbing, may be arranged to form essentially geometric shapes like circles, rectangles, ovals, ellipses, or they may be arranged to form essentially characters of a writing system, or they may be arranged to form essentially logos, trademark signs or brand identifiers, or they may be arranged to form essentially an irregular or random shape, or any combination of such shapes. Any number of said areas may be arranged to form, when viewed from a certain distance, a homogenously reflecting surface or a gradient-reflecting surface.

The major surface of the substrate facing the illumination device may be transmissive or reflecting or absorbing for light of different wavelength regimes. In a specific embodiment, the major surface, may essentially reflect light, from the group of wavelength regimes comprising infrared light, visible light and ultraviolet light, from one or two wavelength regimes, and essentially transmit or absorb light from the remaining wavelength regime(s). It may essentially reflect light from all three wavelength regimes and essentially transmit or absorb light from none of the wavelength regimes. It may essentially reflect light from none of the wavelength regimes, and essentially absorb or transmit light from all three wavelength regimes.

In another specific embodiment, said major surface may essentially absorb light from one or two of said wavelength regimes, and essentially transmit or reflect light from the remaining wavelength regime(s). It may essentially absorb light from all three wavelength regimes and essentially transmit or reflect light from none of the wavelength regimes. It may essentially absorb light from none of the wavelength regimes, and essentially reflect or transmit light from all three wavelength regimes.

In another specific embodiment, said major surface may essentially transmit light from one or two of said wavelength regimes, and essentially absorb or reflect light from the remaining wavelength regime(s). It may essentially transmit light from all three wavelength regimes and essentially absorb or reflect light from none of the wavelength regimes. It may essentially transmit light from none of the wavelength regimes, and essentially reflect or absorb light from all three wavelength regimes.

The major surface may, in particular, reflect visible light and transmit ultraviolet or infrared light. It may transmit visible light and reflect ultraviolet light or infrared light. The major surface of the substrate facing the illumination device may be transmissive or reflecting or absorbing for light of different wavelength regimes in certain areas. Those areas may have geometric shapes like circles, rectangles, ovals, ellipses, or they may have the shape of characters of a writing system, or they may have the shape of logos, trademark signs or brand identifiers, or they may have an irregular or random shape, or any combination of such shapes. A plurality of areas may be arranged to form essentially geometric shapes like circles, rectangles, ovals, ellipses, or they may be arranged to form essentially characters of a writing system, or they may be arranged to form essentially logos, trademark signs or brand identifiers, or they may be arranged to form essentially an irregular or random shape, or any combination of such shapes.

In a preferred embodiment of the present invention, the substrate is impermeable to liquids. In another preferred embodiment of the invention, the light-transmissive film is impermeable to liquids. In a further preferred embodiment, both the substrate and the light-transmissive film are impermeable to liquids, and the attachment of the light-transmissive film to the substrates provides an interface that is impermeable to liquids. This arrangement prevents liquids from entering into the space formed between the light-transmissive film and the substrate, and thus prevents any liquid from reaching the surface of the light-transmissive film that faces the light source, where the liquid could cause degradation of the light-transmissive film or, in some embodiments of the invention, reduce the retroreflectivity of the light-transmissive film by preventing total internal reflection in cube-corner elements of a prismatic retro-reflective light-transmissive film.

In a specific embodiment, the substrate is a vinyl based polymer which is impermeable to liquids, the light-transmissive film is a polymer film comprising a vinyl-acrylate copolymer which is impermeable to liquids, and high-frequency welding is used to attach the light-transmissive film to the substrate, the resulting assembly being essentially impermeable to liquids.

In a specific embodiment, the light guide members and lighting units transmitting light into the light guide members may be contained in the space enclosed by the substrate and the light-transmissive film attached to the substrate, with the substrate, the film and the attachment interface being essentially impermeable to liquids. Electric wires supplying power to the lighting units may be led through the attachment interface in a suitable way, so that the impermeability to liquids is maintained. An advantage of this arrangement is that liquids can not penetrate into the space between substrate and light-transmissive film and can not cause damage to the light guide members, to the lighting units, to the substrate or to the light-transmissive film.

The illumination device can be attached to the substrate, for example, by attaching the light-transmissive film to the surface of the substrate. This method is particularly useful in illumination devices where the extension of the light-transmissive film exceeds at least partly the extension of the light-source so that the outwardly extending portions of the light-transmissive film can be attached to the substrate. In another embodiment the illumination device of the present invention can be applied to the substrate by providing a fixture device having an open frame securing at least part of the edge areas of the light-transmissive film. The frame is then attached to the exposed surface of the article, and the light is emitted through the open area bordered by the frame. This method of attaching the illumination device to a substrate is particularly useful for large area illumination devices. These methods of attaching the illumination device of the present invention to an exposed major surface of the substrate are exemplary only and by no means restrictive.

The light-transmissive film and/or the fixture device can be attached to an exposed surface of the substrate by various methods including thermal welding, high-frequency welding, ultrasonic welding, gluing using adhesive means including pressure-sensitive adhesives or hot-melt adhesives, mechanical fixing, stitching, and sewing, or a combination thereof. Suitable attachment methods for obtaining an attachment of the light-transmissive film to the substrate that is impermeable to liquids, comprise thermal welding, high-frequency welding, ultrasonic welding, and gluing using adhesive means including pressure-sensitive adhesives or hot-melt adhesives.

In order to obtain an attachment of the light-transmissive film to the substrate that is impermeable to liquids, more than one linear attachment area may be chosen. The linear attachment areas may be essentially straight or they may be curved. It may be advantageous to have two parallel attachment lines such as, for example, HF welding lines along an edge of the light-transmissive film, in order to attach it to the substrate in a way that better ensures that the attachment is impermeable to liquids.

The illumination device of the present invention is preferably attached to an exposed surface of the article so that the retro-reflective properties of the illumination device can be enjoyed to the fullest extent. In cases where a decrease of the retro-reflective performance is acceptable and/or where special optical effects may be required it is also possible to arrange the illumination device of the present invention subjacent to the exposed surface. This may be advantageous, for example, in textile articles where the illumination device may be incorporated into pillows, bedclothes, garments and the like.

The illumination devices of the present invention are particularly useful for the application on garments such as clothing for pedestrians, joggers, cyclists and children, bags such as shopping bags, handbags, luggage and back-packs and accessories such as head-, arm- and legbands, gloves, footwear, webbing, pipings, belts, emblems and logos.

The illumination devices of the present invention can furthermore preferably be used in traffic applications to enhance security. The illumination devices can be applied, for example, to automobiles, bicycles or traffic signs.

The illumination device of the present invention can furthermore be used for decorative or advertisement purposes to create fashionable actively illuminated retro-reflective images or emblems.

### DETAILED DESCRIPTION OF THE FIGURES

FIG. 1a is a schematic cross-sectional view of a first embodiment of an illumination device 20 of the present invention comprising an array of discrete lighting units 4 (forming the light source). The lighting units 4 are sandwiched between a substrate 1 and a light-transmissive film 2. The light-transmissive film 2 is secured to the substrate 1 by means of an open frame 7 bordering the light-transmissive film.

The interface between the surface of the light-transmissive film 2 facing the substrate 1 and the discrete lighting units 4 is schematically shown in more detail in FIG. 1b. The surface of the light-transmissive film 2 comprises cube-corner elements 8 contacting the discrete lighting units 4. The cube-corner elements 8 are arranged in grooves and display a randomly tilted configuration. The dihedral angles formed between adjacent cube-corner elements 8 may vary along each groove in the configuration.

FIG. 2 is a schematic cross-sectional view of another embodiment of an illumination device 20 of the present invention which is similar to the construction of FIG. 1 but uses a different light-transmissive film 2 comprising a layer of beads 11 at least partially embedded in a binder layer 12. The binder layer 12 comprises reflective materials such as pearlescent pigments 15 arranged behind the embedded portions of the beads 11. The light-transmissive film 2 comprises another polymeric layer 13 which is arranged below the binder layer 12 and which comprises TiO₂ particles 16. The light-transmissive film 2 rests upon the upper surfaces of the lighting units 4 with the exposed surface of its layer 13 whereas the beads are arranged opposite to such interface and are exposed.

FIG. 3a is a schematic cross-sectional view of another embodiment of an illumination device 20 of the present invention comprising a rod-shaped light guide member 10 having an essentially circular cross-section. The rod-shaped light guide member 10 is secured in an air pocket 9 formed between the light-transmissive film 2 and the substrate 1. The light-transmissive film 2 is secured to the substrate 1 in an attachment area 6. At its lower side facing the substrate 1, the rod-shaped light guide member 10 exhibits notches 5 so that light propagating along the longitudinal extension of the rod-shaped light guide member 10 is extracted or coupled out from the light guide member.

The interface between the surface of the light-transmissive film 2 and the light guide member 10 is schematically shown in more detail in FIG. 3b. The surface of the light-transmissive film 2 comprises cube-corner elements 8 contacting the surface of the light guide member 10. The cube-corner elements 8 are arranged in grooves and display a randomly tilted configuration. The dihedral angles formed between adjacent cube-corner elements 8 may vary along each groove in the configuration.

FIG. 3c is a schematic top view of the illumination device 20 of FIG. 3a. The rod-shaped light guide member 10 which is shown in dashed lines is sandwiched between the light-transmissive film 2 and the substrate 1. A lighting unit 4 such as an LED is arranged at one terminal end of the rod-shaped light guide member 10 so that light is coupled in via the terminal surface of the rod-shaped light guide member 10. The light source 3 of the illumination device 20 of FIGS. 3a-3c is formed by the lighting unit 4 and the rod-shaped light guide member 10.

FIG. 3d is another schematic cross-sectional view of another embodiment of an illumination device 20 of the present invention comprising a rod-shaped light guide member 10 having an essentially rectangular cross-section. The rod-shaped light guide member 10 is secured in an air pocket 9 formed between the light-transmissive film 2 and the substrate 1. The light-transmissive film 2 is secured to the substrate 1 in an attachment area 6. At its lower side facing the substrate 1, the rod-shaped light guide member 10 exhibits notches 5 so that light propagating along the longitudinal extension of the rod-shaped light guide member 10 is extracted or coupled out from the light guide member.

FIG. 4a is a photograph showing a colour-coded image of part of the longitudinal extension (about 3 cm) of the illumination device 20 disclosed in Example 1. The broken line in the middle of the photograph represents the line of pixels along the longitudinal axis of the illumination device, along which luminance data were taken for evaluation as is described in the test method section below. FIG. 4b is a plot showing the luminance distribution along the longitudinal axis of the illumination device disclosed in Example 1. The x-axis is labeled “pixel number” and represents the longitudinal extension along the illumination device so that a higher pixel number corresponds to a larger distance from one end of the rod-shaped light guide member.

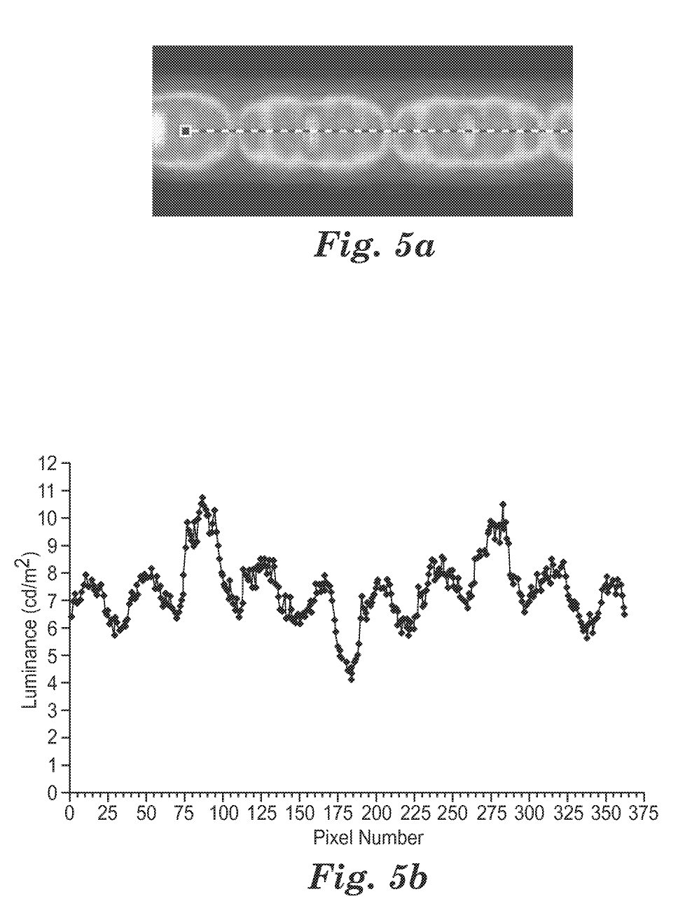

FIG. 5a is a photograph showing a colour-coded image of part of the longitudinal extension (about 3 cm) of the illumination device 20 disclosed in Comparative Example 1. The broken line in the middle of the photograph represents the line of pixels along the longitudinal axis of the illumination device along which luminance data were taken for evaluation as is described in the test method section below. FIG. 5b is a plot showing the luminance distribution along the longitudinal axis of the illumination device disclosed in Comparative Example 1. The x-axis is labeled “pixel number” and represents the longitudinal extension along the illumination device so that a higher pixel number corresponds to a larger distance from one end of the rod-shaped light guide member.

### EXAMPLES

The present invention will be further explained by the following Examples, which are to be considered illustrative and not limiting. Initially, a test method is described that was used in evaluating the Examples.

### Test Methods

### Luminance Distribution and Light Diffusion

An illumination device of the present invention comprising a light source and a light-transmissive film, or, in a separate measurement, the light source alone without the light-transmissive film, respectively, are positioned in front of a black-coloured textile substrate which hangs essentially flat on a wall. The illumination device or the light source, respectively, is arranged so that the direction of the maximum intensity of the emitted light is approximately normal to the surface of the textile substrate (i.e. parallel to the surface vector of the textile substrate). The textile substrate has a specific weight of 220 g/m² and is commercially available under the trade designation “Nomex”, for example, from Theodolf Fritsche GmbH & Co., Helmbrechts, Germany. The textile substrate is normally used for e.g. garments of construction zone workers.

The luminance distribution of the illumination device or the light source alone, respectively, is measured with a CCD-type camera (“CCD” is the common acronym for Charge-Coupled Device and refers to a two-dimensional array of equidistant and equally-shaped image-capturing sensor elements.). The camera used is commercially available under the model designation “LMK 98” from Techno Team Company, Ilmenau, Germany. The CCD sensor of the camera has a resolution of 1280 pixels by 1024 pixels, and its spectral response is approximately flat within the wavelength range of from 450 to 600 nm.

The distance between the exposed surface of the illumination device or the light source, respectively, and the front lens of the measuring device is approximately 70 cm as measured in the central imaging direction of the luminance camera, so that the light source lies completely within the field of view of the luminance camera. The central imaging direction of the camera lens is arranged essentially normal to the surface of the textile substrate.

A dedicated software package, sold with the camera hardware, allows to capture, display and analyze the luminance distribution data of the illumination device or the light source, respectively, or in each case of part of the illumination device or the light source, respectively, on a personal computer. A relative luminance measurement consists of the camera capturing an image of the illumination device or the light source, respectively. The software of the camera automatically applies internal calibration factors and makes available to the user
(i) a colour-coded image of the luminance distribution of the illumination device or the light source, respectively, and
(ii) a set of luminance data for (x; y) coordinates in the image plane for the illumination device or the light source, respectively.

The diffusion properties of the light-transmissive film of the illumination device are obtained from these measurements with the CCD-camera as follows:
1. The luminance variation is determined in each case for the illumination device and the light source, respectively, only one-dimensionally along an arbitrarily selected straight line on the surface of the illumination device or the light source, respectively, which is viewed by the CCD camera. In Example 1 and Comparative Example 1 described below such arbitrarily selected straight line coincided with the central longitudinal axis of the illumination device or the light source, respectively. For illustration purposes, the respective central axis is shown in the colour-coded images of FIGS. 4a and 5a as a dashed line.
2. The average luminance of the illumination device and the light source, respectively, are computed in each case as the arithmetic average of all luminance data points measured on the longitudinal axis of the light source:

L_{avg}=(1/n)ΣLᵢ
where
L_{avg} is the average luminance;
n is the number of data points; and
Lᵢ is the luminance value measured in the i-th pixel number.
Then the spatial variation of the luminance in a direction along the long axis of the light source is determined for both the illumination device and the light source, respectively, by calculating the RMS value (root mean square) per this formula

RMS=[(1/n)Σ(Lᵢ−L_{avg})²]^{1/2}
3. A larger RMS value indicates a larger variation of luminance along the central axis of the illumination device or the light source, respectively, i.e. the presence of brighter and, relative to that, darker areas, whereas a smaller RMS value indicates a smaller variation of luminance or a more even distribution of “brightness” and “darkness”, respectively, of the illumination device or the light source, respectively.
   Therefore, if the RMS value of the illumination device is smaller than the RMS value of the corresponding light source, the luminance distribution of the light source has been evened out by the light-transmissive film. In this case the light-transmissive film is said to have diffusive properties. If the RMS value of the illumination device is essentially equal to the RMS value of the light source, the light-transmissive film does not have diffusive properties but is transparent and/or the luminance distribution of the light source is homogenous.
4. In addition to determining the RMS values, the contrast C of the illumination device or the light source, respectively, is calculated as follows:

C=(Lₘₐₓ−Lₘᵢₙ)/(Lₘₐₓ+Lₘᵢₙ)
where
C is the contrast value;
Lₘₐₓ is the maximum luminance value of all values considered; and
Lₘᵢₙ is the minimum luminance value of all values considered.
For the evaluation of the contrast C, the luminance data points taken by the camera along an arbitrarily selected direction on the light source or along the central longitudinal axis of the light source, respectively, are used.
The lower the contrast value, the more even is the luminance distribution of the illumination device or the light source, respectively. Therefore, if the contrast value C of the illumination device is smaller than the C value of the corresponding light source, the luminance distribution of the light source has been evened out by the light-transmissive film. In this case the light-transmissive film is said to have diffusive properties. If the C value of the illumination device is essentially equal to the C value of the light source, the light-transmissive film does not have diffusive properties but is transparent and/or the luminance distribution of the light source is homogenous.

### Retroreflectivity

Retroreflection is defined in the technical report 54.2-2001 of the “Commission Internationale d'Éclairage” (CIE) as a “reflection in which the reflected rays are preferentially returned in directions close to the opposite of the direction of the incident rays, this property being maintained over wide variations in the direction of the incident rays”.

In order to determine whether the light-transmissive film of the illumination device has retro-reflective properties for light incident in the direction towards the light source on the major surface of the light-transmissive film opposite to the light source, the following qualitative test is performed. The test employs a handheld retroreflection viewing device that is commercially available from 3M Company, St. Paul, Minn., U.S.A. under the trade designation of “3M Confirm™ Handheld Verifiers”. This device emits a beam of white light and allows—through a semitransparent mirror—congruent viewing of a scene, where the viewing direction and light beam direction are collinear.

If the exposed surface of the light-transmissive film is viewed with such hand-held device, the presence of retroreflectivity can be clearly identified by the bright appearance of the surface in a relatively dark environment when the viewer device is switched on, whereas any specularly-reflecting surfaces that turn bright when the viewer device is switched on can be ruled out as not being retro-reflective by varying the observation angle between the observer's line-of-sight to the surface and the surface normal. Only retro-reflective surfaces will appear at the same brightness when the observation angle is varied, for example, by 10° or more.

Retro-reflection can also be determined quantitatively by using an optical setup as described in the document “CIE technical report 54.2”, paragraph 6 and measuring the ratio of the luminous flux returned from the retroreflective surface at the observer's position to the luminous flux normal to the light source incident on the retroreflective surface. For a calibrated light source, this ratio yields the “coefficient of retroreflection” in candela per lux per square meter (cd lx⁻¹ m⁻²).

### Comparative Example 1

A flexible rod-shaped solid light guide member made from transparent polyurethane which is commercially available from 3M Co., St Paul, Minn., U.S.A., under the trade designation “3M™ Precision Lighting Element” was used. The light guide member had a length of approx. 50 cm and a circular cross-section with a diameter of 7 mm. An LED of type L-7104QBC BLUE, available from company Kingbright of City of Industry, U.S.A., arranged next to an end surface of the light guide member, fed visible blue light into the light guide member. The light guide member and the LED together formed a light source.

Light was extracted from the light guide member through a series of surface notches extending into the rod-shaped body of the light guide member. The notches were arranged in groups of 5 notches each with such groups being repeated along the longitudinal extension of the light guide. The notches in a group were arranged normal to the longitudinal axis of the light guide member; they were arranged in a staggered stair-case like arrangement and were spaced from each other by approximately 1 mm. Each notch had a length perpendicular to the long axis of light guide of approximately 1 mm. The groups were equidistantly spaced at approximately 4.3 mm along the longitudinal direction of the light guide member.

According to the test method described above, the assembly of the textile article and the light source (i.e. LED plus light guide member), with no light-transmissive film applied, was brought into the viewing field of the CCD-type camera (“luminance camera”) whereby the flexible light guide member formed an approximately straight rod, and whereby the central viewing direction of the luminance camera was normal to the surface of the textile article and perpendicular to the long axis of the tubular light guide member at a point in the middle of the 50 cm long light guide member. In this position, the luminance camera approximately viewed in the radial direction of maximum intensity of the light emitted from the light guide member.

After switching on the LED, the camera took a picture of the assembly, the measurement values were recorded on a personal computer, and the associated software of the luminance camera determined the luminance value for each image element (pixel).

The luminance data were evaluated as follows:

TABLE 1
Luminance Distribution Of Light Source Without Light-Transmissive Film

| Parameter | Value |
|---|---|
| Number of data points (pixels) | 362 |
| Average Luminance | 8.6 cd/m2 |
| Variation of luminance (RMS) | 1.13 |
| Maximum value of luminance | 10.7 cd/m2 |
| Minimum value of luminance | 4.1 cd/m2 |
| Contrast | 44% |

The upper surface portion of the light guide opposite to the textile substrate was viewed with a handheld retro-reflection viewing device as is described in the test method section above. When switching the viewing device on, the surface of the light guide remained as dull as it appeared with the viewing device switched off, and no retroreflection was detected.

### Example 1

Comparative Example 1 was repeated with the only difference that an illumination device of the invention was obtained by positioning a 40 cm by 60 cm sized piece of a polymeric light-transmissive film over the light source so that the light source was sandwiched between the textile substrate and the light-transmissive film. The construction used corresponds to the construction schematically shown in FIGS. 3a-3c below. The light-transmissive film used is commercially available from 3M Company, St. Paul, Minn., under the trade designation of “3M™ Scotchlite Reflective Material 6560 White High Gloss Sparkle Film”. The major surface of the light-transmissive film which exhibits a cube corner structure was oriented towards the light guide so that the highest portions of the cube corner structure were in contact with the light guide. The other major surface of the light-transmissive film opposite to the cube corner structured major surface, was essentially flat and did not exhibit a cube-corner structure; this other major surface of the light-transmissive film was facing the luminance measuring device.

The assembly of the textile article and the illumination device was arranged in the viewing field of the luminance camera, using an identical geometrical setup as in Comparative Example 1.

After switching on the LED, the camera took a picture of the assembly, the measurement values were recorded on a personal computer, and the associated software of the luminance camera determined the luminance value for each image element (pixel).

The luminance data were evaluated as follows:

TABLE 2
Luminance distribution of illumination device

| Parameter | Value |
|---|---|
| Number of data points (pixels) | 338 |
| Average Luminance | 4.3 cd/m2 |
| Variation of luminance (RMS) | 0.23 |
| Maximum value of luminance | 5.0 cd/m2 |
| Minimum value of luminance | 3.5 cd/m2 |
| Contrast | 18% |

The exposed major surface of the light-transmissive film of the illumination device opposite to the light source was viewed with a handheld retro-reflection viewing device as is described in the test method section above. When switching the viewing device on, the surface of the light-transmissive film appeared much brighter to the observer than it appeared with the viewing device switched off. The surface remained bright when changing the observation angle towards its normal so that retro-reflection was unambiguously detected.

1. Illumination device comprising a light source and at least one light transmissive film arranged above said light source so that at least part of the light emerging from the light source is transmitted through said film, wherein said film has a first major surface facing the light source and a second major surface arranged opposite to said first surface, said light-transmissive film being diffusive for transmitted light incident from the light source on the first major surface and retroreflective for light incident on said second major surface.

2. Illumination device according to claim 1 wherein the light source exhibits a non-uniform distribution of luminance in an arbitrarily selected direction on the light source.

3. An illumination device according to claim 1 wherein the light transmissive film is arranged adjacent to the light source.

4. An illumination device according to claim 1 wherein the light-source comprises at least one light guide member having at least two discrete light extraction elements spaced from each other.

5. (canceled)

6. An illumination device according to claim 4 wherein the at least two discrete light extraction elements are reflecting surfaces extending into the light guide.

7. An illumination device according to claim 5 wherein reflecting surfaces are formed by the walls of notches extending into the light guide.

8. An illumination device according to claim 4 wherein said light guide is made from a flexible polymeric material.

9. An illumination device according to claim 1 wherein the light-source comprises at least two discrete lighting units spaced from each other.

10. (canceled)

11. An illumination device according to claim 8 wherein the lighting units are selected from a group comprising LEDs or discrete electroluminescent sources.

12. An illumination device according to claim 1 wherein the light transmissive film comprises an array of cube-corner elements that are randomly tilted, such array being essentially arranged at the second surface of the film.

13. An illumination device according to claim 1 wherein the film comprises transmissive beads at least partly embedded in a polymer layer comprising reflective material arranged behind the embedded portions of the beads.

14. An illumination device according to claim 11 wherein the reflective material is selected from a group comprising pearlescent pigment and metal.

15. Actively illuminated article comprising a substrate having an exposed major surface and an illumination device according to claim 1 being attached on or subjacent to said exposed major surface.

16. Actively illuminated article according to claim 13 wherein the substrate is selected from a group consisting of polymeric materials, textile materials, woven fabrics, nonwoven fabrics, metal, and wood.

17. Actively illuminated textile article according to claim 13 wherein the substrate comprises a textile article selected from a group consisting of pillows, furnishing fabric, garments, gloves, banners, flags, carpets, curtains, vehicle ceilings, bed textiles, toys, handbags, hats and backpacks.

18. Actively illuminated article according to claim 13 wherein the substrate comprises a polymeric material selected from a group consisting of vinyl, polyurethane, polyester, polypropylene, polyethylene, polymers or copolymers, respectively, or any blends thereof.

19. Actively illuminated article according to claim 13 wherein the substrate exhibits areas having essentially different degrees of reflectivity or differently coloured areas or both.

20. Actively illuminated article according to claim 13, wherein the substrate exhibits in at least a part of its surface a degree of reflectivity for at least one of the wavelength regimes of the group of wavelength regimes comprising visible light, infrared light and ultraviolet light which is essentially different from the degree of reflectivity for the other wavelength regimes of that group.

21. Actively illuminated article according to claim 13, wherein the light-transmissive film is essentially impermeable to liquids, and wherein the substrate is essentially impermeable to liquids, and wherein the light-transmissive film is attached to the substrate in a manner as to form an enclosure that is essentially impermeable to liquids.
